(19) United States
(12) Patent Application Publication
(10) Pub. No.: US 2010/0241497 A1
(43) Pub. Date: Sep. 23, 2010

(54) Method, system and computer software for advertisement, using symbols as characters interface

(76) Inventors: DAN RITTMAN, Atlit (IL); Moshe Schnapp, West Hollywood, CA (US)

Correspondence Address: DAN RITTMAN, Amat Ha Maim 23B, Atlit, 30300, IL

(21) Appl. No.: 12/381,792

(22) Filed: Mar. 18, 2009

(51) Int. Cl. G06Q 30/00

(52) U.S. Cl. 705/14.5; 705/14.73; 705/14.4

(57) ABSTRACT

This paper describes a method, system and a computer software invention for advertising using advertisement material as symbol characters. This invention describes the advertisement method, system and computer software for all types of media. Media may be newspapers, magazines, publications or any type of typed or written (text and graphical based) material. The advertisement method, system and computer software may be used on web sites using any Internet browser interface. This method of advertising is done by inserting advertisement symbols in any desired place within the media page or pages. The advertisement symbols may also replace typical text or graphic characters (ASCII format or any type of image format) in the media page or pages. Advertisement symbols may replace typical textual contents like periods (dots), comas, or any other type of textual or graphical contents. Advertisement symbols may be inserted anywhere in the written material.

### BACKGROUND OF THE INVENTION

1. Field of the Invention

The present invention relates to a system and method for advertising using any media typed or written and internet browser with textual and graphical interface. The present invention takes advantage of the media textual and graphical interface to create a better advertisement-viewing/reading experience for the user on the one hand and more effective delivery of advertisements for the advertiser on the other hand. At the same time, a novel advertisement matching and delivery model in connection with this interface becomes possible and suggests new advertisement methods for the content providers and advertisers, as well as methods for revenue sharing between the involved parties.

2. Discussion of the Background

Currently, documents available on any typed or written media like newspapers, magazines, publications and the Internet are usually represented in the format of “hypertext.” Each hypertext “page” is typically using periods (dots), comas and other symbolic characters representing the context. The same concept is used on the Internet using any type of web browser. This invention describes a method and system to replace any desired symbol, text character or graphics with advertisement symbol. This is the mechanism by which, for example, any corporation may advertise products and/or desired subjects.

Advertisement is a necessary component of modern commerce. Conflicting issues are involved in advertising and include the facts that 1. The advertiser wants to deliver a message to the consumer, so the attention of the consumer has to be captured, and 2. The advertiser must not present the advertisement in a way or to the extent that it hinders the reading/viewing activity of the consumer or annoys the consumer.

Currently, advertisement available on any type of typed or written media like newspapers, magazines, publications and on the Internet are usually are using an entire section and/or a special allocation. The typical advertisement is done using graphical representation of the corporation or product. The typical advertisement is used once or few times in a media form. This is still minimal amount of exposure to the advertisement material. Another disadvantage described by Internet surfers (people who read Internet documents) is that typical advertisement banners and images are ignored due to their appearance and special graphics effects.

Currently, advertisements ads and banners in newspapers, magazines, and Internet web sites are fairly expensive due to the space issue. A page in a newspaper or magazine or any Internet based document is very limited for advertisement space. That is causing higher priced advertisement banners and ads and limits corporations and individuals from advertising within popular media forms like major newspapers, magazines and publications. Furthermore, Internet documents that are presented with special graphical effects may not be view by all Internet surfers due to compatibility issues. If a user is using an old version of an Internet browser he/she may not be able to be exposed to the advertisement material since it was made for the newest technology Internet browsers.

The current advertisement method on the Internet is very restrictive. An advertiser can only display “banner” ads, as explained earlier. This is due to the kind of interface currently available on computers-the Windows interface that derives from the “desktop” metaphor that basically involves a presentation of a series of 2-dimensional “window” interfaces. On this kind of interface, the advertisers either have to contend with a small banner, which does not quite satisfy the need to deliver a message effectively to the consumers, or they have to enlarge the banner that hinders the activities of the consumer and annoys the consumer. Therefore, the parameters of the advertisement are very limited and not necessarily effective.

Another current method of advertisement on the Internet uses a pop-up window whenever the user enters a certain Web page to view data. This type of pop-up window is ineffective for both the consumer and the advertiser. From the point of view of the consumer, pop-up windows are annoying, especially when they are big. From the point of view of the advertiser, pop-up windows are ineffective because the pop-up window, unlike the usual banner advertisements on the Web pages, is not displayed long enough for the consumer to absorb the message. Many consumers simply close the pop-up window or move the desired Web contents into view and relegate the pop-up window to the background. Thus, the pop-up windows are commonly not viewed by the consumer for any period of time.

Moreover, another problem with current browsers and browsing methods relates to their limited ability to identify, contact, and recruit advertisers that will be inserting advertisements into the displayed content.

A similar situation is found in regard to the participants in the process of delivering newspaper/magazine content to consumers, except for the fact that magazine/newspaper publishers actively advertise for others both within and before/after the content. Once again, the entities that deliver the content display have almost no ability to insert advertisements.

In regard to the delivery of television/movies content to consumers, the entities that deliver the display have developed methods of inserting advertisements before the content. For example, movie theaters commonly insert advertisements for themselves and for local businesses prior to the showing of a film. Furthermore, the manufacturers of the display also insert advertisements prior to the start of a film. An example is the advertisements for “DOLBY SURROUND SOUND” commonly shown prior to commencement of the film. In these cases, the entities that deliver the content to the consumer have developed a limited ability to advertise before the delivery of the content.

Advertisement in Internet data transmission has not yet been developed even to the extent known in the delivery of movie/television content displays. There are several entities that participate in delivery of the content to the consumer. A separate web host can maintain and/or update a memory containing the content under the direction of a web publisher. An Internet service provider can transmit the content data from the web host memory to a consumer's site. A browser producer can provide a browser that will decode and generate instructions for displaying the content data at the consumer's site. Finally, a monitor or other output device can display the content under the instructions of the browser.

The insertion of advertisements by each of these entities that deliver Internet content to the consumer is haphazard at best. For example, the web host is entirely unknown to an individual who is accessing content stored on the web host's computers. Internet service providers such as NETZERO place a banner advertisement across the top of the display screen. Thus, this banner is neither inserted into the actual content nor targeted to the content being accessed, and furthermore retains the aforementioned problems of banner advertisements. Monitor manufacturers only include a corporate logo located outside the content display area, and generate no direct advertising revenue thereby.

Advertisements recruited, selected, and displayed by a browser producer are likewise primitive. Both NETSCAPE NAVIGATOR and MICROSOFT INTERNET EXPLORER have limited advertisements to a title of the browser program and one or more corporate trademarks displayed at various locations on the browser window. This prohibits the browser producers from advertising for others than themselves, from inserting the advertisements within the displayed content, and from receiving revenue for the advertisement of various products made by others.

As a result, advertisement is not fulfilling its maximum capability of exposure to viewers in the popular media. The interaction between a reader/browser and the printed advertisement material is not used in the most efficient way to provide the reader/browser with the necessary exposure.

Therefore, the inventors have identified a need for a novel advertisement method and system for typed, printed, written and electronic media that can be also integrated into an Internet documents. Moreover, the inventors have identified a method to significantly increase the exposure to the advertisement material using special advertisement symbols. The inventors have furthermore recognized that advertisement symbols inserted by the typed or printed media and Internet browser can lead to different revenue sharing models. Using the invention described here any media form may significantly increase the reader/browser exposure to the advertisement and therefore benefits the reader and the advertiser.

### SUMMARY OF THE INVENTION

In view of the aforementioned short-comings of presently available schemes for delivering advertisements on popular media like newspapers, magazines, publications, movies and the Internet, one objective of the present invention is to provide a novel method and system for electronic and non electronic advertisement that is modeled after the traditional media. These involve inserting specials symbols of advertisements among the contents that are represented in a media documents. The advertisement symbols inserted in this manner do not obstruct or hinder the reading of the contents to an extent that will annoy the reader.

Another objective of the invention is to provide a novel method and system for inserting full-page, multiple full page or nearly full-page advertisement symbols in between pages or paragraphs of any type of typed, printed or written media. Media may be newspapers, magazines, publications, movies and Internet documents.

Yet another objective of the invention is to provide a novel method and system for inserting advertisement symbols either among the pages or paragraphs that belong to a single electronic or non electronic document or to a Web site currently being browsed using an Internet browser, or between pages or paragraphs belonging to different electronic or non electronic documents or Web sites.

A further objective of the invention is to provide a novel advertisement method and browsing system that significantly increase the material advertised exposure to the readers/browsers.

A yet further objective of the invention is to provide a novel method and system for “dynamically” delivering and/or streaming advertisements to users using a media form or Internet browser to browse information on the Internet.

Another objective of the invention is to provide a novel “static” advertisement delivery method and system where advertisements are pre-delivered and incorporated into the any type of typed, printed material hosted on Web sites.

Yet another objective of the invention is to provide a novel “static” electronic advertisement request method and system which allows users/electronic book authors/content providers to specify the kind of advertisements they are looking for and other parameters of the advertisements so that an automatic advertisement symbols system can identify the relevant advertisements to be incorporated into the electronic books hosted on some Web sites.

A further objective of the invention is to provide a novel “static” electronic advertisement offer method and system which allows advertisers to specify the kind of advertisements they are offering (as well as other parameters of the advertisements) so that an automatic advertisement matching system can identify the relevant advertisements to be offered to electronic book authors or other content providers.

A yet further objective of the invention is to provide an automatic advertisement matching system and method that will automatically match advertisement requests and advertisement offers resident in a database.

Another objective of the invention is to provide a novel method and system for advertisements for theaters and television movies are to appear within the movie title, sub-title, scrolling credits or any other type of document.

Yet another objective of the invention is to provide a privacy-ensured method of dynamically streaming information to an Internet browser so that his or her identity is not compromised.

A further objective of the invention is to provide a revenue sharing method and system for all parties involved in the novel advertisement matching/delivery method and system.

A yet further objective of the invention is to provide computer software for media and Web sites to automatically place the advertisement symbols within media contents and web pages to facilitate matching of advertisers with content providers. The software may also replace any type of textual or graphical character with the desirable advertisement symbols.

Therefore, it is a primary object of the present invention to provide a method and system to place advertisement symbols within media contents to increase the exposure to the readers/browsers benefiting the reader/browser and the advertiser. Another objective of the invention is to enable corporations and individuals to develop better revenue models using this new method of advertisement.

Additional objects, advantages and features of the present invention will become apparent from the following description of its preferred embodiments, which description should be taken in conjunction of the accompanying drawings.

### BRIEF DESCRIPTION OF THE DRAWINGS

FIG. 1 In this drawing we present an example of a document before inserting or replacing advertisement symbols. The document is presented in .DOC (MICROSOFT WORD) format.

FIG. 2 In this drawing we present the same document with the replacement of a period (DOT) with an advertisement symbol. The advertisement symbol that is representing m & m candy, in this example, is replacing every period. (DOT) In same manner every desired character may be replace by any advertisement symbol.

FIG. 3 this is the same document as in FIG. 2 with more advertisement symbols. In this document the advertisement symbols are placed between the paragraphs. The symbols in this example are of the Coca Cola Company.

FIG.4 this is the same document as in FIG. 2 with more advertisement symbols. In this document the advertisement symbols are placed between the sentences. The symbols in this example are of the AOL Company.

### DETAILED DESCRIPTION OF THE PREFERRED EMBODIMENTS

Referring to the sample documents, wherein we show the implementation of the method to advertise through symbols in designated locations.

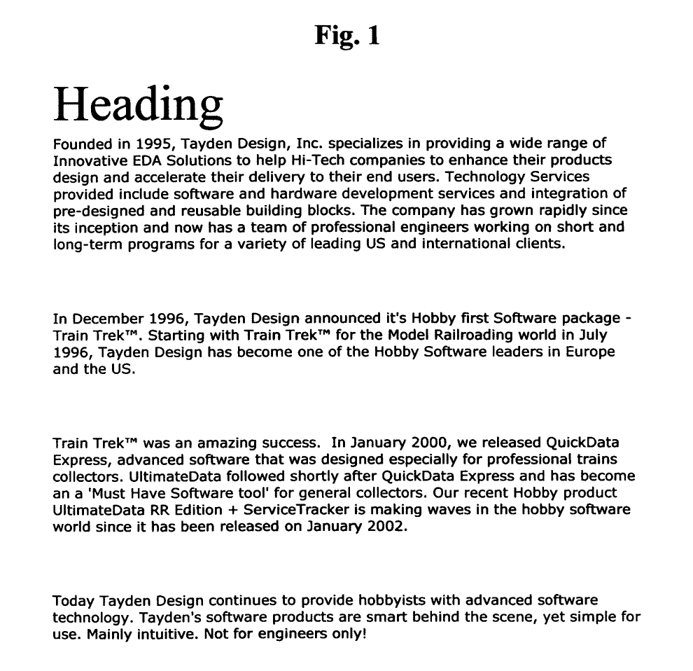

FIG. 1 shows an exemplary basic form that can represent a part of electronic document like an internet web site or a page of any type of media like newspaper, magazine or any other publication.

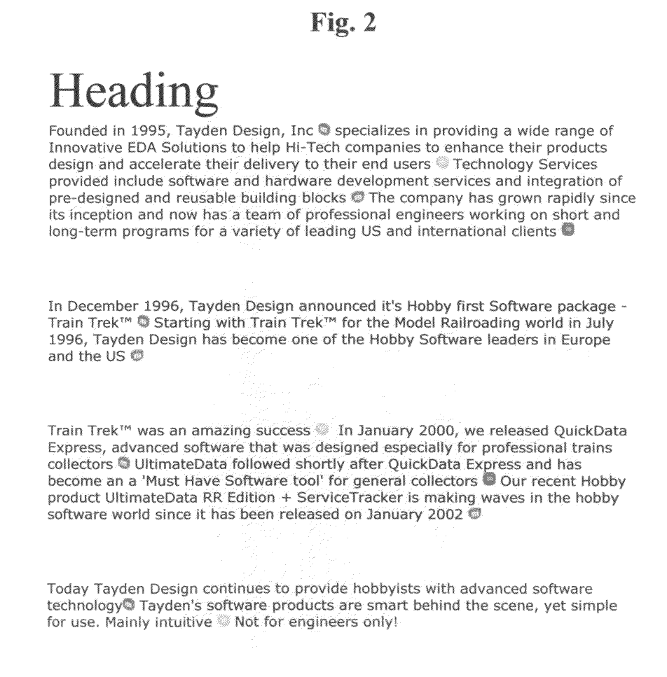

FIG. 2 in this drawing we present the same document with the replacement of a period (DOT) with an advertisement symbol. The advertisement symbol that is representing m & m candy, in this example, is replacing every period. (DOT) In same manner every desired character may be replace by any advertisement symbol. In every place that a period (DOT) was typed in the original document an advertisement symbol is now shown. In this example we choose to replace each period (DOT) with the M&M candy logo.

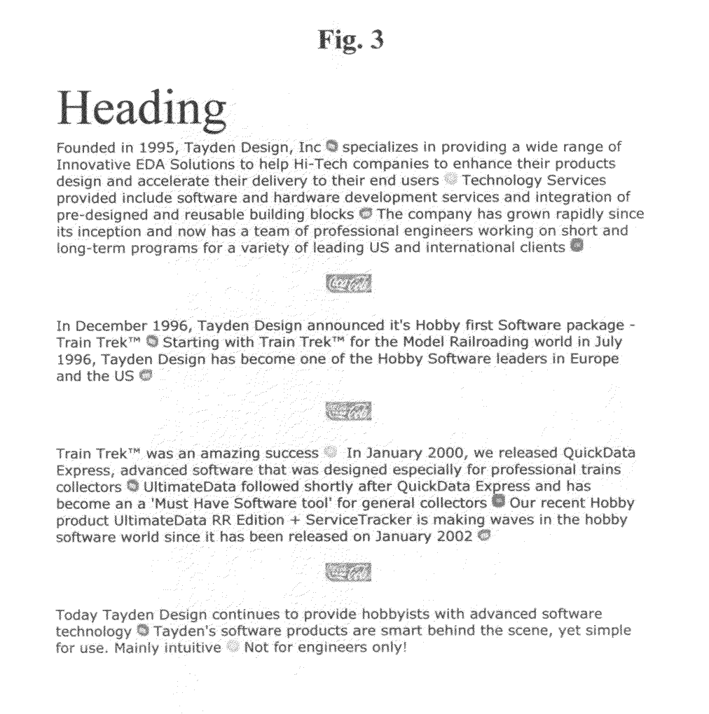

FIG. 3 this is the same document as in FIG. 2 with more advertisement symbols. In this document the advertisement symbols are placed between the paragraphs. The symbols in this example are of the Coca Cola Company.

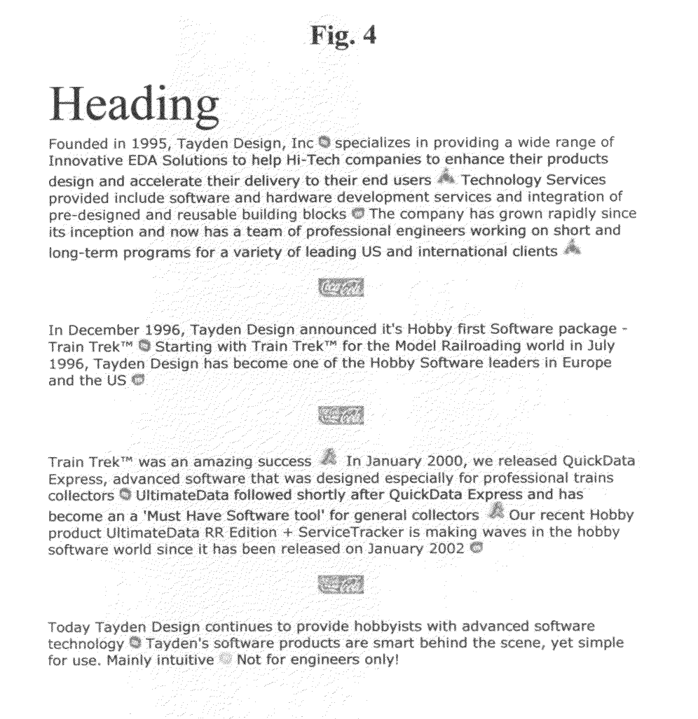

FIG.4 this is the same document as in FIG. 2 with more advertisement symbols. In this document the advertisement symbols are placed between the sentences. The symbols in this example are of the AOL Company.

1. A method for inserting advertisement into a typed or written media contents in a form of symbol characters, comprising steps of:
organizing sequentially said content into a plurality of discrete content amounts;
distributing said plurality of discrete content amounts among one or more flipping pages of a browse able media electronically or non-electronic;
dynamically inserting advertisement symbols at any advertising location within said one or more flipping pages so as to form a flipping page with an embedded advertisement thereon; and
displaying said media page with the embedded advertisement symbols.
Media may be newspapers, Magazines, publications or any type of textual and/or graphical typed material.
Media may be any type of Internet web application or site.
Advertisement symbols may be in black and white or color.

2. The method according to claim 1, further comprising a step of:
reorganizing a portion of said content around said advertising symbol location of said advertisement.

3. The method according to claim 1, wherein
said advising location comprises at least one of a single page and multiple pages.

4. The method according to claim 1, further comprising a step of:
reserving said advertising symbol location of said content for said advertisement.

5. The method according to claim 1, wherein
said advertisement is configured to have a length equal to a discrete content amount length.

6. The method according to claim 1, wherein
said advertisement is configured to have a length equal to a multiple of discrete content amount lengths.

7. The method according to claim 1, wherein
said advertisement is configured to have a length longer than a discrete content amount length.

8. The method according to claim 1, wherein
said displaying step comprises displaying said flipping page with the embedded advertisement in a browse able media form.

9. The method according to claim 1, wherein
said advertisement symbol comprises of a corporation logo or product logo of said flipping page with embedded advertisement within said content.
said advertisement symbol comprises of brand names of said corporations or products with embedded advertisement within said content.
said advertisement symbol on Internet media can be linked to the corporation web site.

10. The method according to claim 9, further comprising a step of:
advancing to a selected position within said electronic media and web page representation.

11. The method according to claim 1, further comprising a step of book marking a particular advertisement symbol.

12. The method according to claim 1, further comprising a step of:
selecting said advertisement based on a predetermined relevance between said advertisement and said contest.

13. The method according to claim 12, wherein said selecting step is performed while said displaying step is performed.

14. The method according to claim 1, further comprising a step of storing said content including said advertisement as one unit.

15. The method according to claim 1, further comprising a step of: placing advertisement symbol on web pages.

16. The method according to claim 1, wherein
said one or more flipping pages includes at least two flipping pages, and
said inserting step comprises inserting said advertisement symbol between said two of said flipping pages, said advertisement comprising at least one of a web-page and an electronic media page.

17. The method according to claim 1, wherein a sequential text and/or graphical display of content comprising:
a browse able media electronic and non-electronic having one or more flipping pages;
at least two discrete amounts of content simultaneously displayed on a single display; and
an indicator of a position of said at least two displayed discrete amounts of content within the content, wherein
one of said at least two discrete amounts of content comprises a n advertisement symbols dynamically inserted at an advertising location within said one or more flipping pages.

18. The method according to claim 1, wherein the display of content according to claim 17, wherein said advertisement comprises an entirety of said one of said at least two discrete amounts of content.

19. The display of content according to claim 17, wherein a second of said at least two discrete amounts comprises a second advertisement symbol.

20. The display of content according to claim 19, wherein said second advertisement symbol comprises an entirety of said second of said at least two discrete amounts of content.

21. The display of content according to claim 20, wherein said advertisement symbol and said second advertisement material originate from a same advertiser.

22. The display according to claim 17, wherein said content comprises content from a plurality of web pages.

23. The display according to claim 24, wherein
said advertisement symbol comprises at least one of a web page and an electronic book page.

24. The method according to claim 1, wherein an electronic display of content, comprising:
means for organizing said content into one or more flipping pages;
means for dynamically inserting an advertisement symbols at an advertising location within said content into one or more flipping pages of any textual and/or graphical media, said content now including said advertisement;
means for dividing said content into a plurality of discrete content amounts; and
means for displaying at least two of said discrete content amounts among one of more flipping pages of a browse able media.

25. A computer readable medium containing program instructions for execution on a computer system, comprising:
means for organizing sequentially a content into more flipping pages than what are simultaneously displayed on a single display including the insertion of advertisement symbols to replace any text character or symbol;
means for dynamically inserting an advertisement symbol at an advertising location within said content into one or more flipping pages;
means for dividing said content into a plurality of discrete content amounts; and
means for displaying at least two of said discrete content amounts among one or more flipping pages of a browse able electronic and non electronic media;

26. The method according to claim 1, further comprising a step of:
placing advertisement symbol on theater and television movies credits, titles and any other type of medium.

27. Software to automatically insert advertisement symbols in desirable locations on any type of media document or Internet based document, comprising steps of:
input is any industry standard text and graphics documents format. Format may be .DOC (MICROSOFT WORD), .TXT. RTF or .HTML.
The user has the feature to define the text or graphics characters to be automatically replaced with advertisement symbol.
